(19) United States
(12) Patent Application Publication
(10) Pub. No.: US 2025/0180375 A1
(43) Pub. Date: Jun. 5, 2025

(54) ALIGNMENT OF INERTIAL MEASUREMENT UNITS WITH MOUNTING STRUCTURES, AND ASSOCIATED SYSTEMS AND METHODS

(71) Applicant: Blue Origin LLC, Kent, WA (US)

(72) Inventors: James Alan Caldwell, Maple Valley, WA (US); Daren Arthur Druhl, Des Moines, WA (US); Thomas Trey Miller, Seattle, WA (US); Shawn M. Lee, Burien, WA (US); Douglas James Brown, Kent, WA (US)

(21) Appl. No.: 18/526,528

(22) Filed: Dec. 1, 2023

(51) Int. Cl. G01C 25/00; G01C 9/02

(52) U.S. Cl. CPC G01C 25/005; G01C 9/02

(57) ABSTRACT

Systems and methods for aligning inertial measurement units (IMUs) with mounting structures. A system can include fiducials attachable to a fixture, a coordinate measuring machine (CMM) for measuring positions of the fiducials, inclinometers attachable to the fixture, and a rate table for receiving the fixture and posing the fixture with the inclinometers and/or the IMUs. A method can include determining a first rotation matrix between a coordinate frame associated with the fiducials and a reference coordinate frame, determining a second rotation matrix between the reference coordinate frame and a coordinate frame associated with a rate table, determining a third rotation matrix between the coordinate frame associated with the rate table and a coordinate frame associated with an IMU, and multiplying the three rotation matrices by data from an IMU. The reference coordinate frame can be a coordinate frame associated with the fixture or associated with one or more inclinometers.

### TECHNICAL FIELD

The present technology is directed generally to alignment of inertial measurement units with mounting structures, and associated systems and methods. Representative features of the present technology include determining the angular relationship between the sensing axes of an Inertial Measurement Unit (IMU) and a mounting fixture.

### BACKGROUND

Inertial measurement units (IMUs) sense movement along one or more axes, and are used in many applications for determining orientation, position, velocity, acceleration, angular rate, and/or other telemetry data. For example, a vehicle may use IMU outputs to aid telemetry analysis. Aerospace systems, such as launch vehicles or other rocket systems, require telemetry data having high degrees of precision. For example, guidance and control applications for launch vehicles may implement body-bending cancelation techniques, which require that the alignment between the sensing axes of the IMU and the object(s) to which the IMU is mounted be precisely calibrated. Guidance and control applications may also need to consider effects on a vehicle from payload deployment, which may also use IMU data. Other systems such as robotic systems, satellite tracking antennas, and other satellite systems may also use IMU data, and may require high degrees of precision from IMUs.

Some IMU manufacturers provide calibration and/or tolerance information, such as a rotation matrix between the internal IMU components and its outer packaging or mounting features. However, calibration and/or tolerance information may not be as accurate and/or precise as is needed for aerospace applications. Existing calibration methods are insufficient for the most precise aerospace needs. Embodiments of the present technology are directed to addressing these challenges and other challenges.

### BRIEF DESCRIPTION OF THE DRAWINGS

In the drawings, wherein the same reference number indicates the same element throughout the views:

FIG. 1 illustrates a partially schematic perspective view of an IMU attached to a body, such as a vehicle structure, in accordance with several embodiments of the present technology;

FIG. 2 illustrates a partially schematic perspective view of a plurality of IMUs attached to a mounting fixture in accordance with several embodiments of the present technology;

FIG. 3 illustrates the mounting fixture shown in FIG. 2 without the IMUs;

FIG. 4 is a pictorial flow diagram illustrating methods and systems for determining the relationship (e.g., a rotation matrix) between a reference coordinate frame based on a plurality of fiducials and an IMU coordinate frame, in accordance with embodiments of the present technology; and

FIG. 5 is a pictorial flow diagram illustrating methods and systems for determining the relationship (e.g., a rotation matrix) between a reference coordinate frame based on a plurality of fiducials and an IMU coordinate frame, in accordance with additional embodiments of the present technology.

### DETAILED DESCRIPTION

Embodiments of the technology disclosed herein are directed generally to systems and methods for aligning inertial measurement units with mounting structures. Although specific implementations of the present technology can include an aerospace system, such as a rocket system and/or launch vehicle, the present technology can also be implemented in other systems in which precise attachment between an IMU and a mounting feature on a body is desired, such as in automobiles, boats, aircraft, consumer devices such as smartphones or gaming devices, buildings, etc.

In general, embodiments of the present technology include systems and methods that calibrate angular relationships between the sensing axes of an IMU and a mounting fixture (e.g., a mounting fixture for attaching the IMU to a vehicle or other system) using capital equipment such as a coordinate measuring machine (CMM), inclinometers (e.g., digital inclinometers), and/or a rate table.

A representative system for determining a rotation matrix between an IMU and a fixture to which the IMU is attachable can include one or more fiducials (such as retro-reflective spheres) attachable to or integral with the fixture, a CMM for receiving the fixture and measuring positions of the fiducials, one or more inclinometers attachable to the fixture, and a rate table for receiving the fixture.

A representative method for determining a rotation matrix between an IMU and a fixture to which the IMU is attachable can include determining a first rotation matrix between a coordinate frame associated with a plurality of fiducials and a coordinate frame associated with the fixture (using a CMM), determining a second rotation matrix between a coordinate frame associated with the fixture and a coordinate frame associated with a rate table (using inclinometers and a rate table), and determining a third rotation matrix between a coordinate frame associated with the rate table and a coordinate frame associated with the IMU (using the IMU and the rate table), and multiplying the rotation matrices together. In some embodiments, the rotation matrix between the IMU and the fixture can be multiplied by a rotation matrix between the fixture and another object (e.g., a vehicle) to form a rotation matrix between the IMU and the other object.

In some embodiments, instead of (or in addition to) using the fixture as a reference coordinate frame, a representative method can include determining a first rotation matrix between a coordinate frame associated with a plurality of fiducials and a coordinate frame associated with one or more inclinometers (e.g., using a CMM when the inclinometers are mounted to a fixture), determining a second rotation matrix between a coordinate frame associated with the one or more inclinometers and a coordinate frame associated with a multi-axis rate table, determining a third rotation matrix between a coordinate frame associated with the rate table and a coordinate frame associated with the IMU, and multiplying the first, second, and third rotation matrices together. Other features and/or embodiments of the present technology are described below.

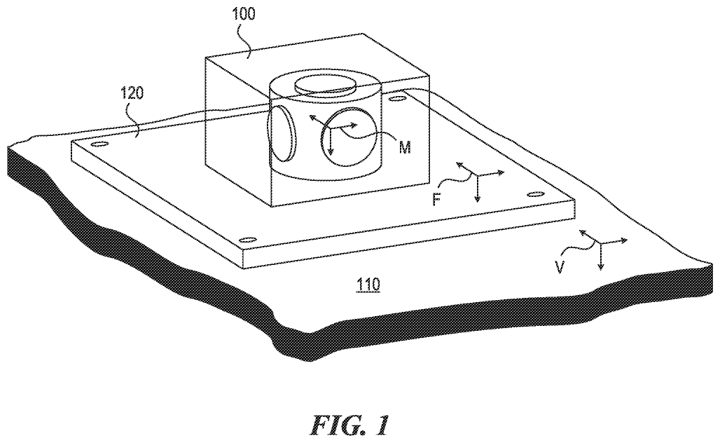

Several details describing structures and processes that are well-known and often associated with metrology and IMUs are not set forth in the following description to avoid obscuring other aspects of the disclosure. Moreover, although the following disclosure sets forth several embodiments, several other embodiments can have configurations, arrangements, and/or components that are different than those described in this section. In particular, other embodiments may have additional elements, and/or may lack one or more of the elements described below with reference to FIGS. 1-5.

Introduction to Calibrating an IMU to a Mounting Fixture and/or a Vehicle

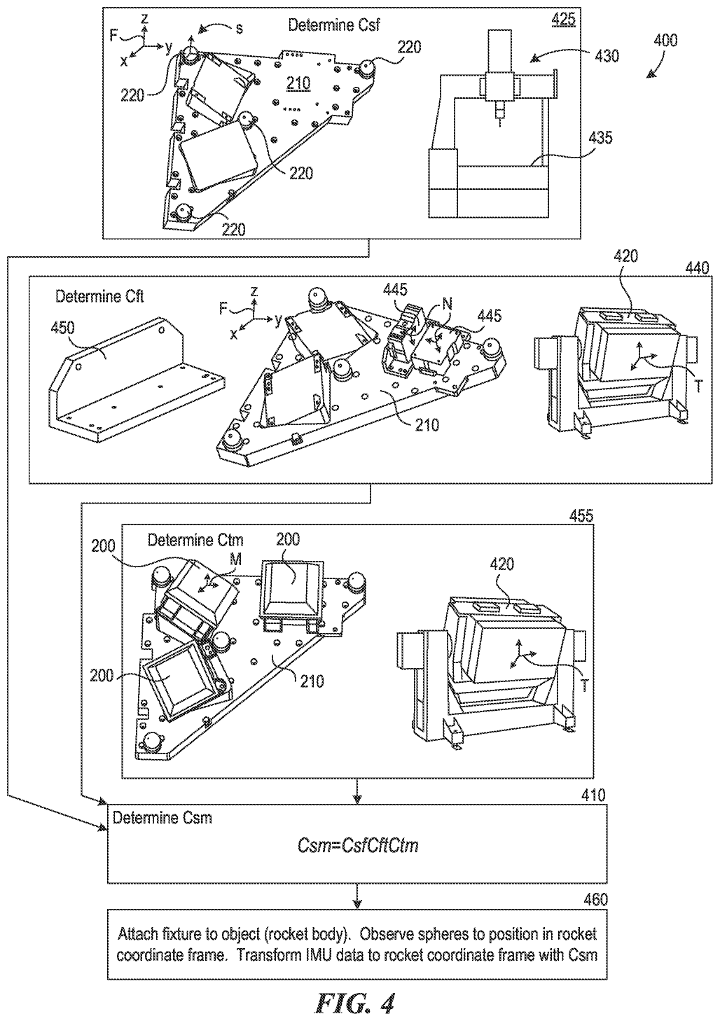

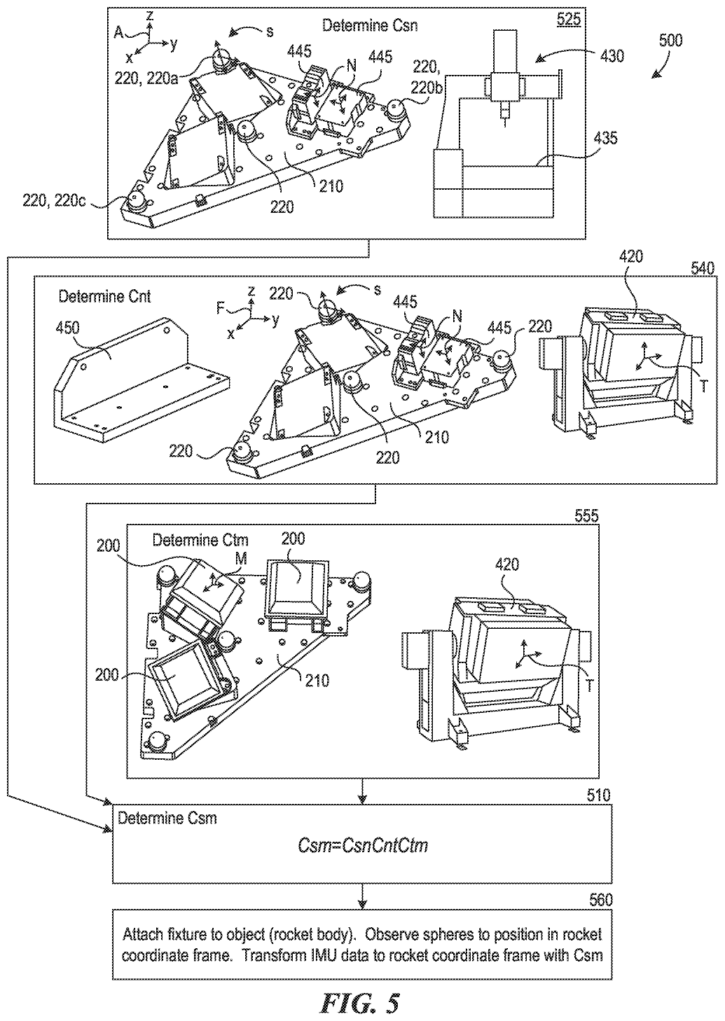

The following description of FIGS. 1-3 introduces concepts, systems, and devices in accordance with embodiments of the present technology. Processes for calibrating an IMU to a mounting fixture are described in further detail sections below in connection with FIG. 4 and FIG. 5.

FIG. 1 illustrates a partially schematic perspective view of an IMU 100 attached to a vehicle structure 110 in accordance with several embodiments of the present technology. In some embodiments, the vehicle structure 110 can include a structural component of a launch vehicle (rocket) body. The vehicle structure 110 and/or the overall launch vehicle body has a coordinate system V. The coordinate system V can be used as a reference for telemetry of the vehicle structure 110 and/or the overall launch vehicle body. The IMU 100 generates data with respect to its own coordinate system M. Although a vehicle structure 110 is described as an example herein, embodiments of the present technology can be implemented in other bodies or structures.

Engineers and other users need to transform (e.g., rotate) data from the IMU coordinate system M to the vehicle coordinate system V in order for vehicle telemetry systems to use the IMU data. Those of ordinary skill in the art will understand that information in one coordinate system can be transformed into a second coordinate system using one or more rotation matrices (e.g., quaternions, direction cosine matrices, etc.). For example, information in the first coordinate system can be multiplied by the rotation matrix using matrix multiplication. What is needed is the rotation matrix to convert data from the IMU coordinate system M to the vehicle coordinate system V (or another suitable coordinate system). Embodiments of the present technology determine such rotation matrices using novel techniques.

In some embodiments, data from the IMU 100, which is initially in the IMU coordinate system M, can be converted to a traceable coordinate frame, such as a coordinate frame F associated with a mounting fixture 120, to which the IMU 100 can be mounted or otherwise attached. The mounting fixture 120 can be attached to the vehicle structure 110, such that the mounting fixture 120 functions as a “middleman” or carrier for the IMU 100 (or for multiple IMUs on the same mounting fixture 120). The relationship between the traceable coordinate frame F and the vehicle coordinate system V can be determined using metrology techniques described in additional detail below. The relationship between the IMU coordinate system M and the traceable coordinate frame F can also be determined using metrology techniques described below in additional detail. The relationship between the IMU coordinate system M and the vehicle coordinate system V can be determined using the relationships between the IMU coordinate system M and the traceable coordinate frame F, and between the traceable coordinate frame F and the vehicle V. Accordingly, in some embodiments, the IMU data is calibrated to the mounting fixture 120, which allows users to convert the IMU data to the vehicle coordinate system V via the mounting fixture coordinate frame F. Note that the coordinate systems described herein (e.g., F, V, and M, etc.) are drawn generally arbitrarily in the figures (unless described otherwise), are not to scale, and may have other origins and/or orientations than those shown in the figures. In some embodiments, instead of using the mounting fixture coordinate frame F, a coordinate frame associated with fiducials or surfaces of inclinometers can serve as the traceable coordinate frame. Fiducials can include objects whose positions can be determined via physical measurements, such as measurements by a CMM or using optical techniques (e.g., a laser tracker). In some embodiments, although spheres are described herein as representative fiducials, suitable fiducials for embodiments of the present technology can include markers or other objects with other shapes.

The relationship between the IMU 100 and the mounting fixture 120 can be characterized as a rotation matrix from the IMU coordinate frame M to the mounting fixture coordinate frame F (the M-F relationship). As explained in further detail below, some embodiments of the present technology determine the M-F relationship using a coordinate measuring machine (CMM), a rate table, inclinometers, and reference points or fiducials such as datum spheres on the mounting fixture 120.

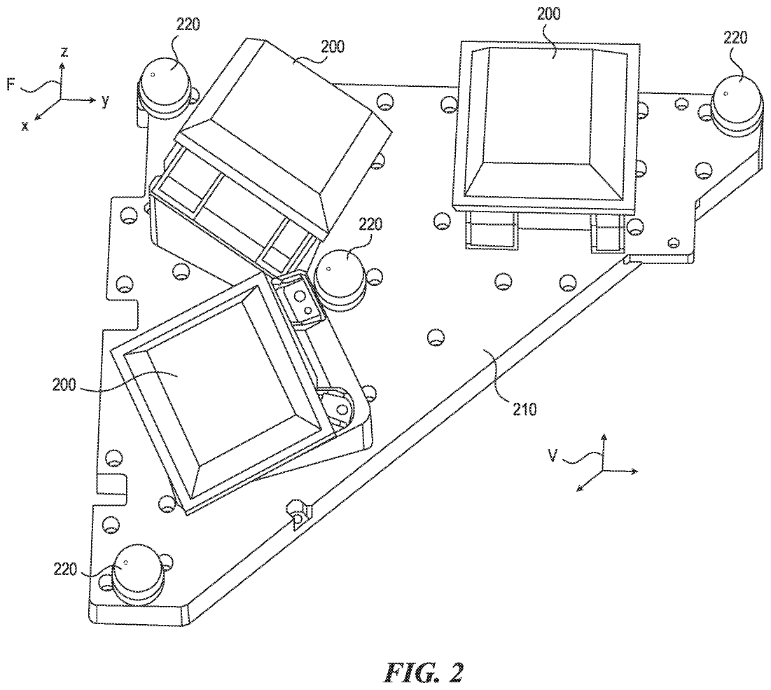

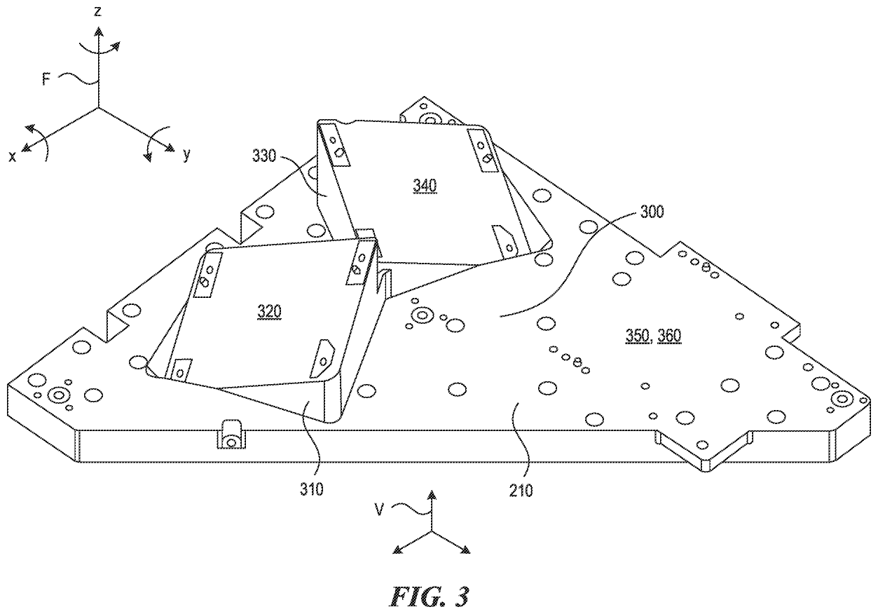

FIG. 2 illustrates a partially schematic perspective view of a plurality of IMUs 200 (e.g., three IMUs 200) attached to a mounting fixture 210 in accordance with several embodiments of the present technology. FIG. 3 illustrates the mounting fixture 210 without the IMUs 200.

With reference to FIGS. 2 and 3, the mounting fixture 210 can be defined and/or characterized relative to the mounting fixture coordinate frame F. The mounting fixture coordinate frame F can be based on any suitable fiducials of the mounting fixture 210. For example, in some embodiments, the mounting fixture coordinate frame F can be based on one or more bolt holes or other features integral to or attachable to the mounting fixture 120. In some embodiments, the mounting fixture 210 carries or includes a plurality (such as two, three, four, or more) of retro-reflective spheres 220 that are visible to visual metrology systems, such as laser trackers. The visual metrology systems can determine the position and orientation of the retro-reflective spheres 220 relative to the vehicle coordinate system V using known metrology techniques. The positions of the spheres 220, in addition to their known positions on the mounting fixture 210, enable a user to determine the relationship (i.e., the rotation matrix) between the mounting fixture coordinate frame F and the vehicle coordinate system V. In other words, when a user and/or a system knows the position and orientation of the mounting fixture 210 (based on the spheres 220), the user and/or system also knows where the IMUs 200 are positioned and oriented in the vehicle coordinate system V, because the IMUs 200 are fixed relative to the mounting fixture 210. The spheres 220 can also be used to determine part of the relationship between the mounting fixture 210 and the IMUs 200, as explained in further detail below.

In some embodiments, the IMUs 200 can be angularly offset from one another. For example, with specific reference to FIG. 3, in some embodiments, the mounting fixture 210 can include a plate element 300 with a first IMU mounting portion 310 having a first IMU mounting surface 320, a second IMU mounting portion 330 having a second IMU mounting surface 340, and/or a third IMU mounting portion 350, with a third IMU mounting surface 360. In some embodiments, one or more of the IMU mounting surfaces 320, 340, 360 (such as each of the IMU mounting surfaces 320, 340, 360) can be angularly offset from, and not coplanar with, one or more (such as each) of the other IMU mounting surfaces 320, 340, 360. For example, in some embodiments, the third IMU mounting surface 360 can be a surface of the plate element 300, and the first and second mounting portions 310, 330 can include blocks or other solid forms extending from the plate element 300 to include corresponding surfaces 320, 340 that are not coplanar with each other and which are not coplanar with the third IMU mounting surface 360. In some embodiments, the plate element 300 can take any suitable form that provides mounting surfaces (such as 320, 340, 350) that are not coplanar with one another. In some embodiments, each IMU 200 can be calibrated to the mounting fixture 210 individually. The angular offset relationship of the IMUs 200 facilitates fault detection and/or isolation of failed sensors within the IMUs 200.

### Determining a Relationship Between a Mounting Fixture and an IMU

FIG. 4 is a pictorial flow diagram illustrating a method 400 and systems for determining the relationship between the mounting fixture coordinate frame F and the IMU coordinate frame M (i.e., the rotation matrix from frame M to frame F). The objects in the diagram of the method 400 are not drawn to scale. In some embodiments, the mounting fixture coordinate frame F can be represented by a coordinate frame associated with fixed features on the mounting fixture 210. For example, in some embodiments, the mounting fixture coordinate frame F can be represented by a coordinate frame S associated with the spheres 220. Accordingly, in some embodiments, the rotation matrix Csm between the coordinate frame S associated with the spheres 220 and the coordinate frame M associated with the IMUs 200 can be used to convert data from the coordinate frame M associated with the IMUs 200 to the vehicle coordinate system V. The following method determines Csm.

Skipping briefly to describe block 410 in the method 400, Csm can be calculated by determining a rotation matrix Csf, which is the rotation between the coordinate frame F associated with the mounting fixture 210 and the coordinate frame S associated with the spheres 220; determining a rotation matrix Cft, which is the rotation between the coordinate frame F and a coordinate frame T associated with a rate table 420 (e.g., associated with the mounting surface of the rate table 420 where objects are fastened for analysis); and a rotation matrix Ctm, which is the rotation between the coordinate frame T and the coordinate frame M. Csm is calculated using matrix multiplication, e.g., Csm=Csf×Cft×Ctm. The following method determines each of the rotation matrices Csf, Cft, and Ctm.

In block 425, the method 400 can include determining Csf. In some embodiments, the method 400 includes operating a coordinate measuring machine (CMM) 430 to determine the positions of the spheres 220 on the mounting fixture 210. Specifically, an operator can position the spheres 220 on the mounting fixture 210, and position the mounting fixture 210 on a surface 435 of the CMM 430. Coordinate frame F of the mounting fixture 210 can be defined as having an origin along an axis of a mounting feature such as a hole or a center of a sphere 220, with a surface of the mounting fixture 210 defining the X-Y plane, and edges forming the X and Y axes, or other suitable arrangements. In other embodiments, other suitable datums can be used to define the coordinate frame F of the mounting fixture 210 on the CMM 430.

The CMM 430 can determine a point cloud of positions around the surface of the spheres 220 (or another suitable datum) in the mounting fixture frame F. The point cloud (sphere cloud) can provide an estimated position of the centers of the spheres 220, which represents the observed (e.g., actual) positions of the spheres 220 in the mounting fixture frame F. The process can be repeated in several iterations, optionally assembling and disassembling the mounting fixture 210 and spheres 220 to determine average measurements for improved accuracy. In some embodiments, the intended or nominal positions of the spheres 220 are known via a computer-aided design (CAD) model of the mounting fixture 210, which positions may be in a different coordinate frame based on the CAD software. Knowing the actual positions of the spheres 220 via the CMM 430 and the nominal positions of the spheres 220 via CAD modeling, a user can determine Csf (the rotation matrix between the spheres 220 and the mounting fixture 210) using known mathematical tools. Specifically, determination of Csf can be an absolute orientation problem in which the solution can involve solving using absolute orientation techniques. In other words, Csf can represent the error between the nominal/CAD model positions of the spheres 220 relative to the mounting fixture 210 and the actual CMM-measured positions of the spheres 220. In some embodiments (which are described in further detail below with regard to FIG. 5), the inclinometers 445 may be mounted to the mounting fixture 210 and the CMM 430 can also determine a point cloud of positions on the surfaces of the inclinometers 445 in order to determine how the inclinometers 445 are oriented relative to the sphere coordinate frame S.

In block 440, the method 400 can include determining Cft (the rotation matrix between the frame F of the mounting fixture 210 and the frame T of the rate table 420). In some embodiments, the rate table 420 can include a multi-axis rate table. Determining Cft can include using one or more inclinometers 445 to represent movement of the mounting fixture 210, and the determination can be performed in two or more ways, examples of which are provided below.

In a first way, the method 400 can include determining a rotation matrix Cnt between inclinometer frames N and the frame T of the rate table 420, determining a rotation Cfn between the mounting fixture frame F and the inclinometer frames N, and combining (matrix multiplying) Cnt with Cfn to result in Cft.

In a second way, the method 400 can include mounting the one or more inclinometers 445 to the mounting fixture 210, positioning the mounting fixture 210 on the rate table 420, and commanding the rate table 420 to move through a number of poses. In some embodiments, the one or more inclinometers can include inclinometers from DigiPas Technologies Inc. of California, or other inclinometers suitable for determining angular positions and outputting usable data. In some embodiments, the operator can move the rate table 420 through a suitable number of poses, such as eight poses for a two-axis table, or another suitable number of poses. In some embodiments, a suitable number of poses can be four poses when bias calibration errors are accounted for prior to performing this second way. Each inclinometer 445 can output offset angles for each pose, and an operator or computer system can record the joint angles of the rate table associated with each pose and the offset angles from the inclinometer 445.

The operator and/or a computer system can form two matrices of data. For example, a first matrix can be a matrix of rate table joint angles in which there are two columns (one for each of the rate table 420 joint angles, e.g., x and y), and M rows, where the number of rows equals the number of poses. The second matrix can be a matrix of inclinometer offset data that includes two columns (x, y) for the inclinometer 445 offset angles and M rows, where the number of rows equals the number of poses. In some embodiments, two inclinometers 445 can be mounted to the mounting fixture 210 in orientations that are orthogonal to each other to ensure that data can be collected even if one of the inclinometers 445 cannot report data due to being outside of its measurement range during one of the poses. Block 440 shows a bracket 450 suitable for attaching one of the inclinometers 445 perpendicular or at an oblique angle relative to another of the inclinometers 445. Although the spheres 220 are visible in block 440, they need not be present to determine Cft.

The matrix of rate table joint angles and the matrix of inclinometer offset data can be input to an optimal state estimator algorithm, such as a Kalman filter algorithm or another suitable state estimator algorithm, to determine Cft. The state variables for the optimal state estimator algorithm (e.g., the Kalman filter) can include potential sources of error (e.g., errors in rate table axes, errors in the orientation of the fixture relative to its expected position on the rate table, e.g., due to mechanical tolerances, errors in orientation of the inclinometers, biases in the inclinometers relative to gravitational direction downward, etc.). A person of ordinary skill in the art understands how to implement an optimal state estimator algorithm, such as a Kalman filter, to determine the rotation between the measurements and state variables to determine the rotation matrix Cft between the frame F of the mounting fixture 210 and the frame T of the rate table 420).

In block 455, the method 400 can include determining Ctm (the rotation matrix between the rate table frame T and the IMU frame M, or the rotation of the IMU data into the rate table frame). In some embodiments, the one or more IMUs 200 can be mounted to the mounting fixture 210, the mounting fixture 210 can be positioned on the rate table 420, and an operator or other controller can command the rate table 420 to move through a number of poses. The number and orientation of the poses can be determined with covariance simulation and validated by Monte Carlo simulation. In some embodiments, the number of poses is at least partially a result of the sensor error in specific IMU devices and/or in specific inclinometer devices (e.g., more poses may be necessary to resolve more error states). In some embodiments, the number of poses may be eight poses, or another suitable number. The IMU output data, in combination with the known positions of the rate table 420 joints, can be processed in an optimal state estimator algorithm (e.g., a Kalman filter) to determine the rotation matrix Ctm.

Although Cft and Ctm can be calculated at separate points in time, in some embodiments, to reduce (e.g., minimize) errors, it is preferable to keep the mounting fixture 210 fastened to the rate table 420 without moving it relative to the rate table 420 between the measurements associated with determining Cft and Ctm (i.e., blocks 440 and 455). Similarly, it can be preferable to leave the IMUs 200 attached to the mounting fixture 210 after they are attached in order to reduce (e.g., minimize) errors that may come from removing and replacing them in a slightly different/shifted location. Although Csf, Cft, and Ctm may be determined and/or calculated in various orders, in some embodiments, such as embodiments in which the IMUs 200 and the inclinometers 445 do not simultaneously fit on the mounting fixture 210, it is preferable to first perform the measurements associated with determining Csf using the CMM 430 (block 425) before performing the measurements associated with determining Cft using the rate table 420 (block 440) and performing the measurements associated with determining Ctm using the rate table 420 (block 455) to avoid removing the IMUs 200 after they are attached to the mounting fixture 210. If the inclinometers 445, the IMUs 200, and the fiducials (e.g., the spheres 220) can all fit on the mounting fixture 210 at the same time, and the resulting assembly can fit on both the CMM 430 and inside the rate table 420, the measurements for Csf, Cft, and Ctm may be performed in any order because there would not be a need to remove and replace components on the mounting fixture 210.

Returning to block 410, the results of blocks 425, 440, and 455 are combined via matrix multiplication to arrive at Csm, as explained above. In block 460, the method 400 can further include attaching the mounting fixture 210 to a vehicle structure 110, such as a launch vehicle (rocket) body. With the mounting fixture 210 attached to the vehicle structure 110, visual metrology systems such as laser trackers can locate and determine the orientation of the mounting fixture 210 via the spheres 220, and using matrix multiplication and Csm, determine an accurate conversion/transformation of the IMU data into the vehicle frame V (see FIG. 1). For example, the IMU data in the vehicle frame V can be determined by multiplying the IMU data by Csm and Cvs, where Cvs is the rotation matrix between the sphere coordinate frame S and the vehicle coordinate frame V, which may already be known to engineers on site and/or can be determined using the visual metrology systems.

### Determining a Relationship Between the Fiducials (e.g., Spheres 220) and an IMU

The method 400 described above assumes that manufacturing tolerances (e.g., for the mounting fixture 210) are sufficient to satisfy requirements. However, in circumstances in which manufacturing tolerances cannot be tightened or are otherwise insufficient, embodiments of the present technology include removing tolerances of the mounting fixture 210 from measurements and calculations by instead using the surfaces of the inclinometers (e.g., a calibrated surface) as reference points. This eliminates the need to understand the interface between the inclinometer reference planes and the resting surfaces on the plate like in the method 400 described with regard to FIG. 4. Accordingly, in some embodiments, the CMM can define one or more coordinate frames using external surfaces of the inclinometers and/or the optical fiducials. In short, instead of using the mounting fixture frame F as a reference coordinate frame, as in the method 400 described with regard to FIG. 4, in some embodiments, the reference coordinate frame can be a different reference frame, such as the reference frame associated with the inclinometers (more specifically, for example, associated with one or more surfaces of the inclinometers).

For example, FIG. 5 is a pictorial flow diagram illustrating a method 500 and systems for determining the relationship between the IMU coordinate frame M and the sphere coordinate frame S. The objects in the diagram of the method 500 are not drawn to scale. In some embodiments, the rotation matrix Csm between the coordinate frame S associated with the spheres 220 and the coordinate frame M associated with the IMUs 200 can be used to convert data from the coordinate frame M associated with the IMUs 200 to the vehicle coordinate system V. The following method provides another way to determine Csm that is unaffected by tolerances of the mounting fixture 210.

Skipping briefly to describe block 510 in the method 500, Csm can be calculated by determining a rotation matrix Csn, which is the rotation between the coordinate frame N associated an inclinometer 445 and the coordinate frame S associated with the spheres 220; determining a rotation matrix Cnt, which is the rotation between the coordinate frame N and a coordinate frame T associated with a rate table 420 (e.g., associated with the mounting surface of the rate table 420 where objects are fastened for analysis); and a rotation matrix Ctm, which is the rotation between the coordinate frame T and the coordinate frame M. Csm is calculated using matrix multiplication, e.g., Csm=Csn×Cnt×Ctm. The following method determines each of the rotation matrices Csn, Cnt, and Ctm.

In block 525, the method 500 can include determining Csn. In some embodiments, the method 500 includes operating the CMM 430 to measure the mounting fixture 210 to construct a frame of reference A based on the as-built features of the mounting fixture 210. Using the CMM 430, the method 500 can include determining the positions of the spheres 220 in frame A (e.g., by estimating the centers of the spheres 220 based on the positions of their surfaces). The positions of the spheres 220 in the frame A can define a frame of reference S that is isolated from effects of the tolerances associated with the mounting fixture 210. For example, a first vector from a first sphere (e.g., sphere 220a at a corner of the mounting fixture 210) to a second sphere (e.g., sphere 220b) can define the x axis of the S frame. A second vector from the first sphere to a third sphere (e.g., sphere 220c) can define a temporary y axis. As is understood in the vector mathematics, the cross product of the x axis and the temporary y axis define the z axis of the S frame. Crossing the z axis with the x axis results in the true y axis of the S frame. In other embodiments, the S frame can be defined in other suitable manners.

Before, after, and/or concurrently with defining the S frame, the method 500 can include determining the inclinometer frame N in the “as-built” positions of the inclinometers 445 on the mounting fixture 210. In some embodiments, to determine the N frame, an operator can select two orthogonal planes of the inclinometer 445 (e.g., an xy and xz plane in the N frame of reference, and/or two other planes of the inclinometer, such as calibrated side surfaces of the inclinometer). In some embodiments, these planes can be determined with the CMM 430 based on the three highest points on each of the two orthogonal sides. The normal vector in the S frame from each of the orthogonal planes establishes two axes of the N frame, and the cross product of the normal vectors from each of the orthogonal planes establishes the third axis. Using matrix mathematics one can then determine the rotation matrix between the N frame and the S frame, which is Csn.

In block 540, which can be performed prior to, or after, block 525, the method 500 can include determining Cnt (the rotation matrix between the frame N of the inclinometers 445 and the frame T of the rate table 420). Cnt can be determined in a similar manner as described above with regard to block 440 in FIG. 4. For example, with the inclinometers 445 on the mounting fixture 210, use the rate table 420 to rotate the inclinometers 445 and the mounting fixture 210 through a sequence of poses and collect data from the inclinometers to estimate Cnt. In some embodiments, Cnt can be estimated using the rate table 420 by gathering data from the inclinometers 445 while each inclinometer 445 is oriented in two poses. A first pose can include the inclinometer being nearly level to the local level plane, and a second pose is offset by 180 degrees about the local level plane.

In block 555, which can be performed prior to, or after, block 525 and/or block 540, the method 500 can include determining Ctm (the rotation matrix between the rate table frame T and the IMU frame M, or the rotation of the IMU data into the rate table frame). In some embodiments, Ctm is determined in the same manner or a similar manner as in block 425 for the method 400 described above with regard to FIG. 4.

Although Cnt and Ctm can be calculated at separate points in time, in some embodiments, to reduce (e.g., minimize) errors, it is preferable to keep the mounting fixture 210 fastened to the rate table 420 without moving it relative to the rate table 420 between the measurements associated with determining Cnt and Ctm (i.e., blocks 540 and 555). Similarly, it can be preferable to leave the IMUs 200 and the inclinometers 445 attached to the mounting fixture 210 after they are attached in order to reduce (e.g., minimize) errors that may come from removing and replacing them in a slightly different/shifted location. Csn, Cnt, and Ctm may be determined and/or calculated in various sequences.

Returning to block 510, the results of blocks 525, 540, and 555 are combined via matrix multiplication to arrive at Csm, as explained above. In block 560, the method 500 can further include attaching the mounting fixture 210 to a vehicle structure 110, such as a launch vehicle (rocket) body. With the mounting fixture 210 attached to the vehicle structure 110, visual metrology systems such as laser trackers can locate and determine the orientation S frame via the spheres 220, and using matrix multiplication and Csm, determine an accurate conversion/transformation of the IMU data into the vehicle frame V (see FIG. 1). For example, the IMU data in the vehicle frame V can be determined by multiplying the IMU data by Csm and Cvs, where Cvs is the rotation matrix between the sphere coordinate frame S and the vehicle coordinate frame V, which may already be known to engineers on site and/or can be determined using the visual metrology systems.

In some embodiments, the common frame in which data from the CMM is gathered can be any suitable reference frame. In some embodiments described above, the common frame can be the frame F, the frame A, the frame N, or another suitable common reference frame. In some embodiments, the inclinometer reference surfaces (e.g., the orthogonal surfaces or planes of the inclinometers 445) can be measured on the CMM in the sphere coordinate frame S. For example, the distance from the spheres 220 to the inclinometer reference surfaces can be measured on the CMM, with the measurement errors from those distances being the only major contributors to uncertainty in the relationship between the spheres and the inclinometers. Accordingly, in some embodiments, the frame of reference A, which is described above as being constructed using the fixture 120, can be constructed instead using the relationship between the spheres 220 and the inclinometers 445, which can further reduce CMM measurement errors. In such embodiments, a method can include constructing a frame of reference using the spheres 220 as measured by the CMM, estimating the sphere centers using the data from the CMM in the sphere frame of reference, measuring the inclinometer surfaces in the sphere frame of reference, and determining the rotation matrix Csn from the sphere frame of reference (based on the sphere centers, e.g., frame S) to an inclinometer frame of reference (based on the inclinometer surfaces, e.g., frame N).

One feature of several embodiments described above is precise and/or accurate rotation matrices for characterizing orientation of one coordinate frame with respect to another in order to convert data among the coordinate frames. An advantage of this feature is improved reliability, precision, and/or accuracy of the data. Another feature of several embodiments described above is that the methods can utilize commercially available metrology tools, such as the CMM, rate table, spheres, and/or off-the-shelf instrumentation, such as commercially available inclinometers and IMUs. An additional advantage of this feature includes reduced (e.g., minimized) reliance on custom tooling and/or instrumentation. Another feature of several embodiments described above is that the systems and methods can be applied to any application in which a rotation matrix between an IMU and a mounting fixture for the IMU is needed. Accordingly, embodiments of the present technology can improve reliability, accuracy, and/or precision of many implementations of IMUs. Other advantages of several embodiments of the present technology include the elimination of a need for equipping an IMU with mirrors and/or optical targets to calibrate it to a vehicle or other object, and less of a need for tight tolerances on mounting fixtures. Rate tables utilized in systems and methods according to embodiments of the present technology do not need to be perfectly level.

From the foregoing, it will be appreciated that specific embodiments of the disclosed technology have been described herein for purposes of illustration, but that various modifications may be made without deviating from the technology. For example, although a CMM is disclosed, embodiments of the present technology can include other systems and/or devices suitable for measuring positions and/or dimensions. Although a rate table is disclosed, embodiments of the present technology can include other systems and/or devices suitable for positioning and/or orienting objects. Embodiments of the present technology can include mounting fixtures shaped, sized, or otherwise configured in suitable manners other than those disclosed herein. In some embodiments, a mounting fixture may be omitted and a portion of the object to which the IMU(s) is/are to be attached can stand in for the mounting fixtures disclosed herein. In some embodiments, the optical fiducials can be fixed relative to the IMUs(s) without using a mounting fixture. Although retro-reflective spheres 220 are described herein, in other embodiments, one or more of the spheres 220 can be replaced with other suitable optical targets or fiducials.

Although specific quantities, dimensions, or other numerical characterizations are provided for context and/or to indicate representative embodiments, various further embodiments can have other quantities, sizes, or characteristics (for example, sizes, quantities, and/or characteristics commensurate with strength requirements or other variables). Although some embodiments of the present technology determine and use rotation matrices, other embodiments can determine and use other transformation matrices. Although Kalman filtering and Kalman filters are described above in connection with determining various matrices, the term “Kalman filter” can include various types of Kalman filters such as Extended Kalman Filters. Other embodiments of the present technology can include other suitable optimal state estimation algorithms using state variables, and/or other suitable algorithms in addition to, or as alternatives to, Kalman filter algorithms.

Certain aspects of the technology described in the context of particular embodiments may be combined or eliminated in other embodiments. Further, while advantages associated with certain embodiments of the disclosed technology have been described in the context of those embodiments, other embodiments may also exhibit such advantages, and not all embodiments need necessarily exhibit such advantages to fall within the scope of the present technology. Accordingly, the present disclosure and associated technology can encompass other embodiments not expressly shown or described herein.

As used herein, the term “and/or” when used in the phrase “A and/or B” means “A, or B, or both A and B.” A similar manner of interpretation applies to the term “and/or” when used in a list of more than two terms. As used herein, the terms “generally” and “approximately” refer to values or characteristics within a range of ±10% from the stated value or characteristic, unless otherwise indicated.

Many embodiments of the technology described herein may take the form of computer- or controller-executable instructions, including routines executed by a programmable computer or controller. Those skilled in the relevant art will appreciate that the technology can be practiced on computer/controller systems other than those shown and described herein. The technology can be embodied in a special-purpose computer, controller, or data processor that is specifically programmed, configured, or constructed to perform one or more of the computer-executable instructions described herein. Accordingly, the terms “computer” and “controller” as generally used herein refer to any data processor and can include Internet appliances and hand-held devices (including palm-top computers, wearable computers, cellular or mobile phones, multiprocessor systems, processor-based or programmable consumer electronics, network computers, mini computers, and the like). Information handled by these computers can be presented at any suitable display medium, including an LCD.

The technology can also be practiced in distributed environments, where tasks or modules are performed by remote processing devices that are linked through a communications network (e.g., a wireless communication network, a wired communication network, a cellular communication network, the Internet, and/or a short-range radio network such as Bluetooth). In a distributed computing environment, program modules and/or subroutines may be located in local and remote memory storage devices. Aspects of the technology described herein may be stored and/or distributed on computer-readable media, including magnetic or optically readable or removable computer disks, as well as distributed electronically over networks. Data structures and transmissions of data particular to aspects of the technology are also encompassed within the scope of the embodiments of the technology.

I/We claim:

1. A system for determining a rotation matrix between (a) an inertial measurement unit (IMU) and a fixture to which the IMU is attachable or (b) an IMU and one or more fiducials attachable to or integral with the fixture, the system comprising:
the fixture,
the one or more fiducials attachable to or integral with the fixture;
a coordinate measuring machine (CMM) positionable to receive the fixture and to measure positions of the fiducials;
one or more inclinometers, wherein the one or more inclinometers are attachable to the fixture; and
a rate table positionable to receive the fixture when the one or more inclinometers are attached to the fixture.

2. The system of claim 1, wherein the fixture is attachable to a vehicle.

3. The system of claim 2, wherein the vehicle is a launch vehicle or a portion of a launch vehicle.

4. The system of claim 1, wherein the rate table is a two-axis rate table.

5. The system of claim 1, wherein the one or more fiducials comprise retro-reflective spheres.

6. The system of claim 1, wherein the one or more inclinometers include two inclinometers, and wherein the two inclinometers are positionable at a perpendicular or oblique angle relative to one another.

7. The system of claim 1, wherein the fixture comprises a plate element, wherein the plate element comprises a first IMU mounting portion and a second IMU mounting portion, wherein the first IMU mounting portion comprises a first IMU mounting surface, the second IMU mounting portion comprises a second IMU mounting surface, and the first IMU mounting surface is angularly offset, and not coplanar with, the second IMU mounting surface.

8. A method for determining a rotation matrix between a coordinate frame associated with an inertial measurement unit (IMU) and a coordinate frame associated with a plurality of fiducials supported on a fixture to which the IMU is attachable, the method comprising:
(a) determining a first rotation matrix, the first rotation matrix being a rotation between a coordinate frame associated with a plurality of fiducials and a coordinate frame associated with one or more inclinometers, wherein determining the first rotation matrix comprises: (i) using a coordinate measuring machine (CMM) to determine positions of the fiducials on the fixture in a common measurement frame, (ii) defining the coordinate frame associated with the plurality of fiducials, (iii) defining a coordinate frame associated with the one or more inclinometers when the one or more inclinometers are mounted to the fixture, and (iv); determining a relationship between the coordinate frame associated with the plurality of fiducials and the coordinate frame associated with the one or more inclinometers when the one or more inclinometers are mounted to the fixture;
(b) determining a second rotation matrix, the second rotation matrix being a rotation between a coordinate frame associated with the one or more inclinometers and a coordinate frame associated with a multi-axis rate table, wherein determining the second rotation matrix comprises:
positioning the fixture on the rate table when the one or more inclinometers are mounted to the fixture;
commanding the rate table to move through a plurality of first poses;
for each first pose, recording first joint angles of the rate table;
for each first pose, recording offset angles output from each inclinometer; and
using the first joint angles and the offset angles to determine the second rotation matrix;
(c) determining a third rotation matrix, the third rotation matrix being a rotation between a coordinate frame associated with the rate table and a coordinate frame associated with the IMU, wherein determining the third rotation matrix comprises:
commanding the rate table to move through a plurality of second poses when the fixture is on the rate table and the IMU is mounted to the fixture;
for each second pose, recording output of the IMU;
for each second pose, recording second joint angles of the rate table; and
using the second joint angles and the output of the IMU to determine the third rotation matrix;
(d) using matrix multiplication, multiplying the first, second, and third rotation matrices together.

9. The method of claim 8, wherein the common measurement frame is a coordinate frame associated with the fixture.

10. The method of claim 8, wherein defining the coordinate frame associated with the plurality of fiducials comprises:
(a) defining a first vector from a first fiducial to a second fiducial;
(b) defining a second vector from the first fiducial to a third fiducial;
(c) defining a third vector using a cross product of the first vector and the second vector; and
(d) defining a fourth vector using a cross product of the third vector and the first vector;
wherein the coordinate frame associated with the plurality of fiducials is defined by the first, third, and fourth vectors.

11. The method of claim 8, wherein defining the coordinate frame associated with the one or more inclinometers when the one or more inclinometers are mounted to the fixture comprises:
defining a first vector normal to a first plane of a surface of the one or more inclinometers;
defining a second vector normal to a second plane of a surface of the one or more inclinometers, wherein the second vector is orthogonal to the first vector; and
defining a third vector using a cross product of the first vector and the second vector; wherein
the first vector, the second vector, and the third vector define the coordinate frame associated with the one or more inclinometers.

12. The method of claim 8, wherein:
(a) using the first joint angles and the offset angles to determine the second rotation matrix comprises inputting the first joint angles and the offset angles into an optimal state estimator algorithm, wherein state variables for the optimal state estimator algorithm include one or more errors in joint angles of the rate table, one or more errors in orientation of the fixture and/or the one or more inclinometers, and/or one or more mechanical tolerances; and/or
(b) using the second joint angles and the output of the IMU to determine the third rotation matrix comprises inputting the second joint angles and the output of the IMU into an optimal state estimator algorithm.

13. The method of claim 8, wherein:
(a) determining the first rotation matrix is performed before determining the second rotation matrix and the third rotation matrix; or
(b) determining the second rotation matrix is performed before determining the first rotation matrix and the third rotation matrix; or
(c) determining the third rotation matrix is performed before determining the first rotation matrix and the second rotation matrix.

14. The method of claim 8, wherein using the CMM to determine positions of the fiducials comprises using the CMM to determine positions of retro-reflective spheres mounted on the fixture.

15. The method of claim 8, wherein the one or more inclinometers comprises two inclinometers, and wherein the two inclinometers are positioned at a perpendicular or oblique angle relative to one another on the fixture.

16. A method for converting data between a coordinate frame associated with an inertial measurement unit (IMU) and a coordinate frame of a body to which the IMU is attachable, wherein the data comprises a position, an orientation, a velocity, an acceleration, and/or an angular rotation rate, the method comprising:
(a) determining a first rotation matrix for converting data between a coordinate frame associated with a plurality of fiducials and a reference coordinate frame;
(b) determining a second rotation matrix for converting data between the reference coordinate frame and a coordinate frame associated with a rate table;
(c) determining a third rotation matrix for converting data between the coordinate frame associated with the rate table and a coordinate frame associated with the IMU;
(d) using matrix multiplication, multiplying the first, second, and third rotation matrices together to form a fourth rotation matrix;
(e) determine a fifth rotation matrix between the fiducials and a body upon which the fiducials are attachable; and
(f) multiplying the fourth rotation matrix by the fifth rotation matrix and data from the IMU; wherein
the reference coordinate frame is either (i) a coordinate frame associated with a fixture carrying the fiducials or (ii) a coordinate frame associated with one or more inclinometers.

17. The method of claim 16, wherein the reference coordinate frame is the coordinate frame associated with a fixture carrying the fiducials, and wherein determining the first rotation matrix comprises using a coordinate measuring machine (CMM) to determine positions of the fiducials on the fixture in the coordinate frame associated with the fixture, and comparing the positions of the fiducials on the fixture to a computer-aided design model of the fixture.

18. The method of claim 16, wherein the reference coordinate frame is the coordinate frame associated with one or more inclinometers, and wherein determining the first rotation matrix comprises using a coordinate measuring machine (CMM) to determine the reference coordinate frame using surfaces of the one or more inclinometers.

19. The method of claim 16, wherein determining the second rotation matrix comprises:
commanding the rate table to move through a number of poses while supporting one or more inclinometers;
for each pose, recording joint angles of the rate table;
for each pose, recording offset angles output from each inclinometer; and
using the joint angles and the offset angles to determine the second rotation matrix.

20. The method of claim 16, wherein determining the third rotation matrix comprises:
commanding the rate table to move through a number of poses while supporting the IMU;
for each pose, recording output of the IMU;
for each pose, recording joint angles of the rate table; and
using the joint angles and the output of the IMU to determine the third rotation matrix.
